(19) United States
(12) Patent Application Publication
(10) Pub. No.: US 2009/0032564 A1
(43) Pub. Date: Feb. 5, 2009

(54) Gas combustion type striking tool

(76) Inventors: Hajime Takemura, Tokyo (JP); Junichi Tamura, Tokyo (JP); Keijiro Murayama, Tokyo (JP); Katsuhiko Murayama, Tokyo (JP)

Correspondence Address: DRINKER BIDDLE & REATH (DC), 1500 K STREET, N.W., SUITE 1100, WASHINGTON, DC, 20005-1209, US

(21) Appl. No.: 11/920,549

(22) PCT Filed: May 17, 2006
(86) PCT No.: PCT/JP2006/309819

§ 371 Date: Nov. 16, 2007

(30) Foreign Application Priority Data
May 17, 2005 (JP) 2005-144123

(51) Int. Cl. B25C 1/08

(52) U.S. Cl. 227/10

(57) ABSTRACT

A front portion of a feed cylinder of a feed piston-cylinder mechanism is communicated with a combustion chamber, and a rear portion of the feed cylinder is sealed. A check valve and a spring which constantly biases a feed piston toward a nail feed direction in the forward direction are provided. An opening valve communicating with the rear portion of the feed cylinder is provided. The opening valve is opened after or just before a completion of a returning operation of a striking piston.

### TECHNICAL FIELD

The present invention relates to a gas combustion type striking tool.

### BACKGROUND ART

As an example of a gas combustion type striking tool, there is known a combustion-gas driven striking machine which is operable to: inject combustible gas into a combustion chamber sealed inside a body; stir mixed gas of the combustible gas and air inside the combustion chamber; burn the mixed gas thus stirred inside the combustion chamber to generate high-pressure combustion gas inside the combustion chamber; and act the high-pressure combustion gas on a striking piston accommodated inside a striking cylinder to strikably drive the striking piston inside the striking cylinder, thereby striking a nail supplied to a nose portion beneath the body into a steel plate or a concrete with a driver coupled to the lower surface side of the striking piston. Such combustion-gas driven striking machines are configured as a portable tool equipped with a vessel, such as a gas container, which is filled with combustible gas and is arranged inside the tool, and a battery which serves a power source for igniting the combustible gas and is attached to the tool. Thus, a work for striking a nail or a pin can be carried out without being restricted by power supply sources such as electric power or compressed air.

The gas combustion type striking tool as described above is provided with a feeding mechanism which sequentially feeds coupled fasteners housed inside a magazine toward the nose portion. In some feeding mechanisms, linearly coupled fasteners are housed within a sheath-shaped magazine, and the coupled fasteners are constantly pressed toward a side of the nose portion by a spring having a constant output, whereby, immediately after the first fastener supplied at a shooting port of the nose portion is driven, the subsequent fastener is supplied inside the nose portion.

Because the number of fasters that can be housed inside such straight-type magazines is small, some gas combustion type striking tools are equipped with a cylindrical magazine inside which fasteners coupled in a coiled manner are housed.

A feed piston-cylinder mechanism is generally used as a fastener feeding mechanism for cylindrical magazines. The feed piston-cylinder mechanism is configured such that a feed piston is slidably accommodated inside a feed cylinder and is provided with a feed pawl engagable with the coupled fasteners housed inside the magazine, whereby the feed pawl reciprocates in a nail feed direction in which the feed pawl is fed toward the side of the nose portion and in a retracting direction opposite thereto.

When the gas combustion type striking tool employs the cylindrical magazine together with the feed piston-cylinder mechanism, the feed piston of the feed piston-cylinder mechanism may be reciprocated by utilizing a spring and a pressure of the combustion gas inside the combustion chamber. More specifically, the combustion chamber may be coupled to a front portion of the feed cylinder through a gas tube so that the feed piston is reciprocated such that it is fed forwardly by the spring and is retraced by the gas pressure form the gas tube.

However, according to the aforesaid configuration, when the fastener is struck by driving the driver together with the striking piston, the combustion gas inside the combustion chamber is simultaneously fed to the feed cylinder to retract the feed piston. Thereafter, when the combustion gas is cooled so that the pressure inside the combustion chamber becomes negative pressure, the striking piston returns due to the pressure difference. Simultaneously, the pressure inside the gas feeding portion of the feed cylinder also becomes negative pressure, whereby the feed piston moves in the nail feed direction due to the spring force. At this time, since the movement of the feed piston due to the spring force is faster than the returning movement of the striking piston, there sometimes arises a phenomenon that the front fastener being fed toward the nose portion by the feed pawl of the feed piston hits the driver that is still returning. This is because, while the fastener is energized toward the nail feed direction by the spring force, the retuning force of the striking piston caused by the negative pressure of the combustion chamber is not so strong. Thus, the front fastener scraped against the driver. As a result, the driver sometimes fails to return due to the frictional resistance caused by the slidable contact.

Therefore, JP 5-72380 U discloses a technique in which a check valve is provided in the gas tube while a discharge valve is provided in the front portion of the feed cylinder. In this configuration, the feed pawl is operated by sending the combustion gas into the front portion of the feed cylinder to retract the feed piston, holding the retracted state, and then opening the discharge valve after the completion of the striking operation to discharge the gas inside the front portion of the feed cylinder.

However, the check valve and the discharge valve are provided near the tip end of the nose portion where it is likely to be exposed to an environment in which dust such as wood chips or fine particles of concrete is attached. Thus, it is difficult to ensure the sealing property of the valves which opens and closes in such an environment. When the valve is not surely sealed, the pressure of the feed piston can not be held. In such a case, a delaying operation of the feed piston becomes uncertain, so that the problem of scraping may arise.

### DISCLOSURE OF THE INVNETION

One or more embodiments of the invention provide a gas combustion type striking tool operable to delay a feeding operation of a feed piston in a piston-cylinder mechanism for feeding fasteners relative to a returning operation of a striking piston in order to surely prevent scraping against a driver.

According to one or more embodiments of the invention, a gas combustion type striking tool includes a combustion chamber inside which mixed gas obtained by mixing and stirring combustible gas and air is combusted, a striking piston which is driven by an action of the combustion gas, a driver which is coupled to a lower surface of the striking piston, a nose portion which guides the driver to slide and from which a fastener is struck, a feed pawl which is engagable with coupled fasteners housed inside a magazine, a feed piston which is coupled to the feed pawl and reciprocates the feed pawl along a direction in which the fattener is fed toward the nose portion, a check valve which is provided at a rear end portion of a feed cylinder inside which the feed piston is accommodated, an opening valve communicating with a rear portion of the feed cylinder. The feed piston is biased by a spring toward the direction in which the fattener is fed toward the nose portion. A front portion of the feed cylinder communicates with the combustion chamber. The opening valve is opened after or just before a completion of a returning operation of the striking piston.

According to one or more embodiments of the invention, the gas combustion type striking tool further includes a link member which is coupled to a side wall of the combustion chamber, extends dounwardly from the striking cylinder, and is movable in a vertical direction, and a contact member which is disposed so as to be engagable with the link member, and is relatively movable along the nose portion in the vertical direction. The link member is constantly biased downward by a spring. The opening valve is opened interlockingly with the link member when the link member moves downward together with the side wall of the combustion chamber after the fastener is struck.

According to one or more embodiments of the invention, the gas combustion type striking tool further includes a link member which is coupled to a side wall of the combustion chamber, extends dounwardly from the striking cylinder, and is movable in a vertical direction, and a contact member which is disposed so as to be engagable with the link member, and is relatively movable along the nose portion in the vertical direction. The link member is constantly biased downward by a spring. The opening valve is opened interlockingly with a movement of the contact member.

According to one or more embodiments of the invention, the opening valve includes an electromagnetic valve which is opened after or just before the completion of the returning operation of the striking piston.

According to one or more embodiments of the invention, the opening valve is disposed inside the gas combustion type striking tool.

According to one or more embodiments of the invention, a gas combustion type striking tool includes a combustion chamber inside which mixed gas obtained by mixing and stirring combustible gas and air is combusted, a striking piston which is driven by an action of the combustion gas, a driver which is coupled to a lower surface of the striking piston, a nose portion which guides the driver to slide and from which a fastener is struck, a feed pawl which is engagable with coupled fasteners housed inside a magazine, a feed piston which is coupled to the feed pawl and reciprocates the feed pawl along a direction in which the fattener is fed toward the nose portion, and a check valve having a narrowing hole and is provided at a rear end portion of a feed cylinder inside which the feed piston is accommodated. The feed piston is biased by a spring toward the direction in which the fattener is fed toward the nose portion. A front portion of the feed cylinder communicates with the combustion chamber.

According to one or more embodiments of the invention, at the time of the striking operation, the gas pressure is supplied to the front portion of the feed cylinder in accordance with the combustion inside the combustion chamber, and the feed piston moves in the retracting direction. Thereafter, since the rear space of the feed cylinder is sealed even when the pressure in the front portion is reduced, the piston stops at the position where the spring force and the negative pressure balance. Thus, since the feed pawl can not perform the feed operation, the fastener is prevented from contacting with the driver while the returning operation of the striking piston, whereby the scraping can be prevented. Thus, the returning operation of the striking piston can be surely performed. Thereafter, the opening valve opens after or just before the completion of the returning operation of the striking piston, whereby the feed piston is operated to feed the fastener. Accordingly, the feed operation of the feed piston can be delayed from the operation of the striking piston so that the scraping against the driver can be surely prevented.

According to one or more embodiments of the invention, when the link member moves together with the side wall of the combustion chamber after the fastener is struck, the fastener is fed in response to the opening of the opening valve interlockingly with this movement. Thus, the feed operation of the feed piston can be delayed surely.

According to one or more embodiments of the invention, when the nose portion moves so as to separate from the material to be fastened after the fastener is struck, the fastener is fed in response to the opening of the opening valve interlockingly with the movement of the contact member. Thus, the feed operation of the feed piston can be delayed surely.

Further, since the opening operation is not performed by the release of the sealing or another valve mechanism but is performed interlockingly with the contact member which moves mechanically, the frequency of failure can be reduced and the reliability can be maintained for a long time.

According to one or more embodiments of the invention, since the opening valve includes the electromagnetic valve which is opened after or just before the completion of the returning operation of the striking piston, a power source for igniting the mixed gas by an electric spark can be used, whereby the feed operation of the feed piston can be surely delayed with a compact configuration. According to one or more embodiments of the invention, since the opening valve is disposed within the gas combustion type striking tool, even when the driving operation is performed within the environment where dust such as wood chips or fine particles of concrete is likely to be attached, the sealing property of the opening valve is ensured, whereby the operation of the feed piston can be surely delayed.

According to one or more embodiments of the invention, since the narrowing hole is provided at the check valve instead of the opening valve, the feed operation of the feed piston caused by the spring force after the completion of the driving operation is braked, whereby the feed operation of the feed piston can be surely delayed.

### BRIEF DESCRIPTION OF THE DRAWINGS

FIG. 1 is a longitudinal sectional diagram showing main portions of a gas combustion type nailer in a non-operated state.

FIG. 2 is a front longitudinal sectional diagram showing a relation between a contact arm and a link member.

FIG. 3 is a longitudinal sectional diagram showing the nailer at the time of a nailing operation.

FIG. 4 is a longitudinal sectional diagram showing a moving end of the feed pawl of the nailer.

FIG. 5 is a longitudinal sectional diagram showing a state after the nailing operation of the nailer.

FIG. 6 is a longitudinal sectional diagram showing a returning state after the the nailing operation by the feed piston of the nailer.

FIG. 7 a front view showing a half of the main portions in which an operation mode of the nailer when lifted immediately after the nailing is illustrated.

FIG. 8 is a timing chart showing a shift between timings of the feed pawl and a striking piston.

### EXPLANATION OF REFERENCE NUMERALS

5 combustion chamber

7 feed piston-cylinder mechanism

15 contact arm

21 feed cylinder

22 feed piston

26 gas tube

32 opening valve

### BEST MODE FOR CARRYING OUT INVENTION

Hereinafter, an embodiment of the invention will be explained with reference to the drawings.

A striking tool according to the invention is not limited to a nailer explained hereinafter. The invention may also be applied to a striking tool in which a power is transmitted by combustion and which feeds a fastener such as coupled rod members having heads (a nail, a screw) or coupled rod members having no head (a parallel pin).

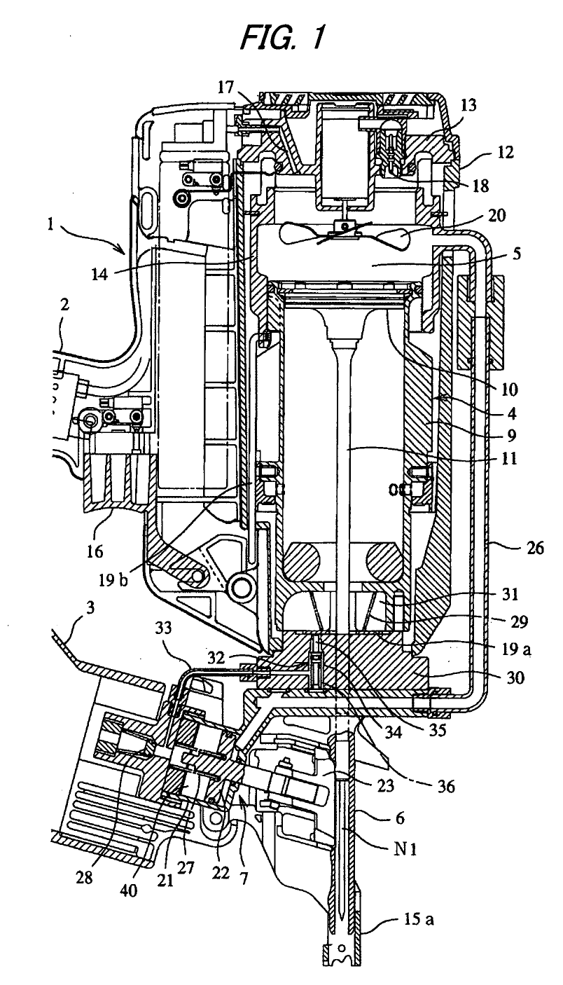

In FIG. 1, reference numeral 1 indicates a body of the gas nailer. The body 1 is provided with a grip 2 and a magazine 3 coupled to each other, and is further provided with a striking piston-cylinder mechanism 4, a combustion chamber 5, a nose portion 6 and a feed piston-cylinder mechanism 7 for feeding nails.

In the striking piston-cylinder mechanism 4, a striking piston 10 is slidably accommodated inside a striking cylinder 9, and a driver 11 is integrally coupled to a lower portion of the striking piston 10.

The combustion chamber 5 is formed by an upper end surface of the striking piston 10, an upper wall (cylinder head) 13 formed between the striking cylinder 9 and an upper housing 12, and an annular movable sleeve 14 disposed therebetween. The combustion chamber 5 is configured such that the closed combustion chamber 5 is formed when the movable sleeve 14 is moved upward, whilst an upper portion of the combustion chamber 5 communicates with the outer air when the movable sleeve 14 is moved downward.

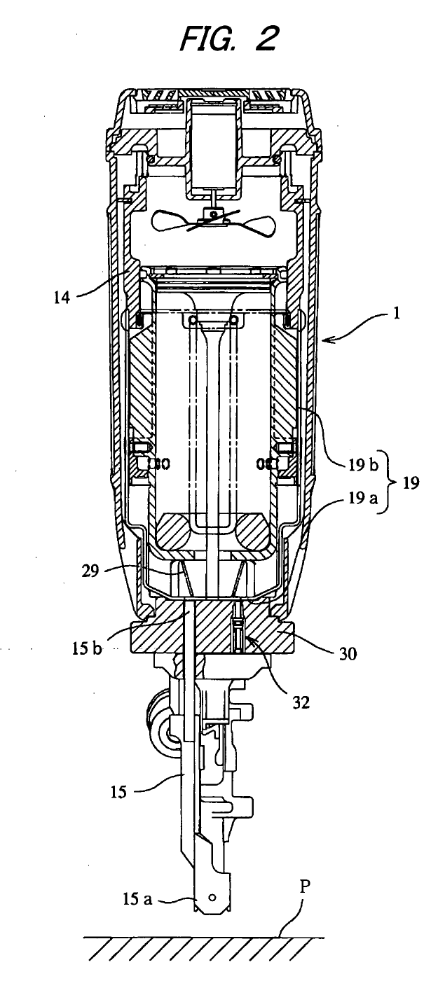

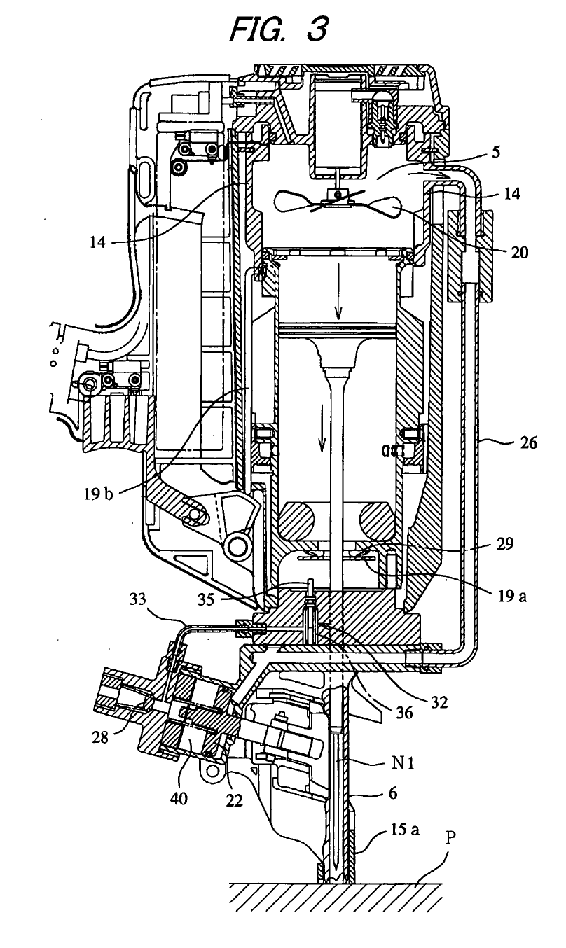

More specifically, as shown in FIG. 2, the movable sleeve 14 is linked to a contact arm 15, serving a contact member, via a link member 19. The link member 19 includes a basket-shaped bottom portion 19a disposed below the striking cylinder 9 and an arm portion 19b extending along an outer surface of the striking cylinder 9 from an end portion of the basket-shaped bottom portion 19a. An upper end of the arm portion 19b is coupled to the movable sleeve 14, and the basket-shaped bottom portion 19a is biased downward by a spring 29 disposed between the basket shaped bottom portion 19aand a lower surface of the striking cylinder 9. The contact arm 15 is provided so as to slidable in a vertical direction along the nose portion 6. A tip end 15a of the contact arm 15 protrudes from the nose portion 6. When the tip end 15a is pressed against a material P to be nailed together with the nose portion 6, the tip end 15a moves upward relative to the nose portion 6 (see FIG. 3). A lower surface of the basket-shaped bottom portion 19a of the link member 19 engages with an upper end 15b of the contact arm 15. Thus, when the nose portion 6 is pressed against the material P, the contact arm 15 relatively moves upward to push up the link member 19 against a spring 29, thereby moving the movable sleeve 14 upward. Accordingly, a space inside the combustion chamber 5 is shut off from the outer air, whereby the combustion chamber 5 is closed.

In contrast, when the nailer is lifted upward due to a reaction generated immediately after the nailing, the contact arm 15 moves downward along the nose portion 6 due to its own weight. However, the pressure inside the combustion chamber 5 is negative immediately after the nailing. When the striking piston 10 moves up to its original position and the combustion chamber 5 is opened to the outer air, the movable sleeve 14 and the link member 19 relatively moves downward by the spring 29 and engages and mates with the contact arm again as shown in FIGS. 1 and 2.

An injection nozzle 17 communicating with a gas vessel (not shown), and an ignition plug 18 for igniting and firing mixed gas are disposed inside the upper housing 12. A rotary fan 20 is also provided inside the upper housing 12. The rotary fan 20 stirs the combustible gas injected inside the combustion chamber 5 and the air inside the combustion chamber 5 to create mixed gas having a predetermined air-fuel ratio inside the combustion chamber 5.

The nose portion 6 guides the sliding operation of the driver 11, and is opened to the magazine 3.

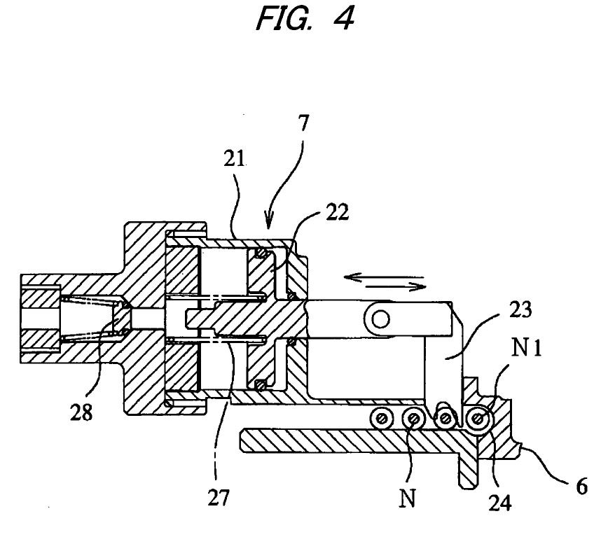

As shown in FIG. 4, in the feed piston-cylinder mechanism 7, a feed pawl 23 is coupled to the feed piston 22 (including a piston rod) which is slidably accommodated inside a feed cylinder 21, and the feed piston 22 and the feed pawl 23 are reciprocated in a nail feed direction in which the feed pawl 23 engages with coupled nails housed inside the magazine 3 to feed the coupled nails toward a side of the nose portion 6 and in a retracting direction opposite thereto. When the feed piston 22 is moved to the moving end of the feed direction as shown in FIG. 4, the a front nail N1 of coupled nails N is pushed into a shooting port 24 of the nose portion 6. Thus, in a state where the feed piston 22 is located at the moving end position of the feed direction, the coupled nails do not move so that the front nail N1 is held within the shooting port 24.

A front portion of the feed cylinder 21 of the feed piston-cylinder mechanism 7 is communicated with the combustion chamber 5 via a gas tube 26. A spring 27 is provided in a rear portion of the feed cylinder 21, and constantly biases the feed piston 22 toward the feed direction, i.e., in the forward direction. A rear portion of the feed cylinder 21 is sealed and provided with a check valve 28.

A guide member 30 for the driver 11 is provided between the striking cylinder 9 and the nose portion 6. A space portion 31 is formed between the guide member 30 and a bottom portion of the striking cylinder 9. An opening valve 32 is provided within the guide member 30. The opening valve 32 communicates with the rear portion of the feed cylinder 21 via an air path 33. A valve stem 35 is slidably disposed inside a valve cylinder 34 in the vertical direction, and is constantly biased upward by a spring 36. A tip end of the valve stem 35 is configured so as to protrude into the space portion 31 when the valve stem 35 is pushed and moved upward by the spring 36.

The tip end of the valve stem 35 of the opening valve 32 is engagable with the bottom portion 19a of the link member 19. The bottom portion 19a is normally brought into contact with an upper surface of the guide member 30 by the force of the spring 29. Thus, as shown in FIG. 1, the valve stem 35 of the opening valve 32 is normally also pushed into the valve cylinder 34 against the spring force of the opening valve 32, and is located at the lower dead point at which the path 33 is opened toward the outer air. In contrast, when the valve stem 35 is at an upper dead point, the path 33 is shut off from the outer air.

Next, operations of the aforesaid operation delay mechanism will be explained. As shown in FIG. 3, when stating a nailing operation, the tip end of the nose portion 6 is strongly pressed against the material P to be nailed so as to relatively move up the contact arm 15, whereby the movable sleeve 14 moves upward to form the closed combustion chamber 5. Further, the combustible gas is injected into the combustion chamber 5 from the injection nozzle 17, and the rotary fan 20 rotates to stir and mix the combustible gas and the air.

Further, when the contact arm 15 moves upward to push up the link member 19, the bottom portion 19a thereof moves away from the upper surface of the guide member 30. Thus, the valve stem 35 of the opening valve 32 moves upward by the force of the spring 36 and moves to its upper dead point where the path 33 is shut off from the outer air. Accordingly, the rear space 40 of the feed cylinder 21 becomes closed by the opening valve 32, the check valve 28 and the feed piston 22.

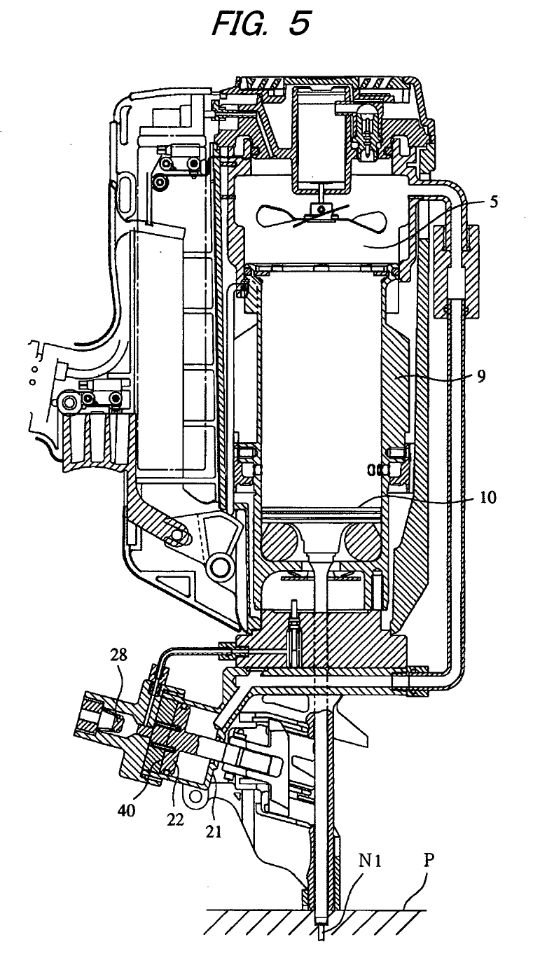

Then, when a trigger 16 is pulled, the ignition plug 18 ignites the mixed gas so that the mixed gas burns and explosively expands. This pressure of the combustion gas acts on the upper surface of the striking piston 10 and drives the striking piston downward, whereby the driver 11 strikes the front nail N1 supplied inside the nose portion 6 into the material P, as shown in FIG. 5.

Simultaneously, the pressure of the combustion gas inside the combustion chamber 5 is also supplied to the feed cylinder 21 of the feed piston-cylinder mechanism 7, whereby the feed piston 22 moves in the retracting direction against the spring as shown in FIG. 5. Since the rear space 40 of the feed cylinder 21 is compressed in accordance with the movement of the feed piston 22, the check valve 28 is opened against the spring, whereby the compressed air inside the rear space 40 is discharged toward the outer sir from the check valve 28. As a result, the feed piston 22 moves in the retracting direction toward the rear end of the feed cylinder 21.

As described above, at the time of the nailing operation, the striking piston 10 performs the striking operation in accordance with the combustion inside the combustion chamber 5, and then the feed piston 22 performs the retracting operation.

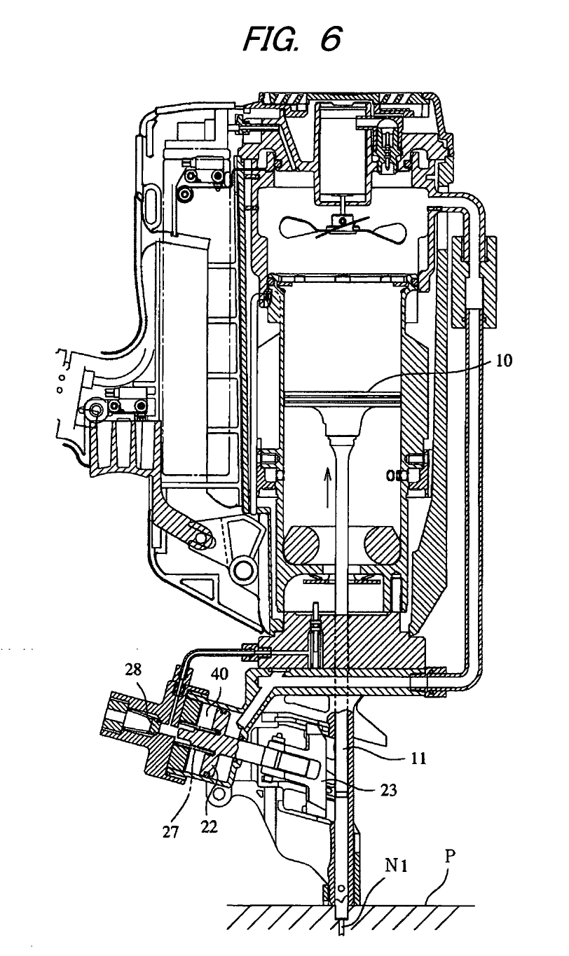

When the nailing is completed, the temperature inside the combustion chamber 5 decreases rapidly. Therefore, the volume of the combustion gas inside the combustion chamber 5 changes so as to reduce back to an original volume so that the pressure in a space above the striking piston 10, which is expanded to the striking cylinder 9, becomes negative. Thus, the striking piston 10 retunes to its upper dead position as shown in FIG. 6 due to the pressure difference with respect to the outer air below. Similarly, because the pressure inside the gas tube 26 reduces, the feed piston 22 moves in the nail feed direction by the force of the spring 27. However, as described above, the rear space 40 of the feed cylinder 21 is closed. Therefore, the pressure inside the rear space becomes a negative pressure when the feed piston 22 moves in the nail feed direction. Then, the feed piston 22 stops at a position where the spring force and the negative pressure balance. Accordingly, the feed pawl 23 cannot be fed so that the front nail of the coupled nails is not supplied to the shooting port 24 of the nose portion 6. Thus, the front nail does not contact with the driver 11 while the striking piston 10 is returning so that the scraping thereagainst can be prevented. Consequently, the striking piston 10 can be surely returned.

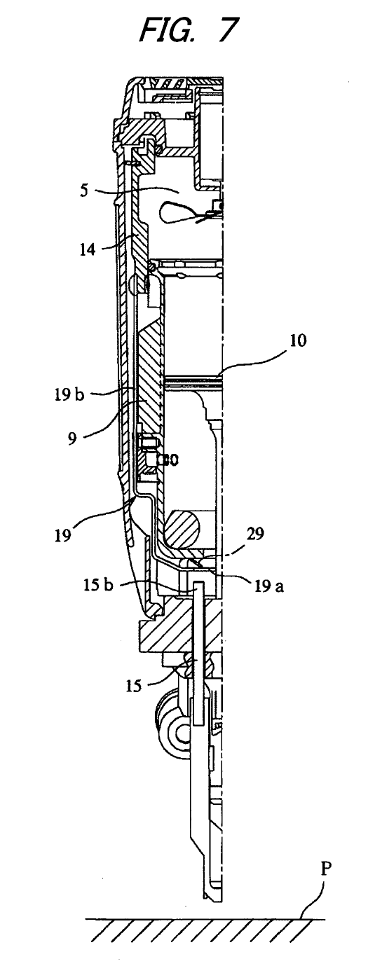

In contrast, when the nailer moves up due to a reaction generated immediately after the nailing, the contact arm 15 moves downward along the nose portion 6 due to its own weight as shown in FIG. 7. Then, the temperature inside the combustion chamber 5 reduces rapidly so that the pressure in the upper space of the striking piston 10 expanded to the striking cylinder 9 becomes negative. When the striking piston 10 moves up to the original position (upper dead point), the combustion chamber 5 is opened to the outer air, and the pressure thereof becomes equal to the atmospheric pressure. Then, the movable sleeve 14 and the link member 19 relatively move downward by the spring 29 as shown in FIG. 1, whereby the bottom portion 19a pushes the valve stem 35 of the opening valve 32 downward. Thus, the opening valve 32 opens the rear space 40 of the feed cylinder 21 to the outer air so that the air is suctioned into the feed cylinder 21 via the opening valve 32, whereby the pressure inside the feed cylinder 21 increases. Therefore, the feed piston 22 moves in the nail feed direction by the force of the spring 27 so that the front nail N1 is supplied into the nose portion 6, whereby the next nailing operation is prepared.

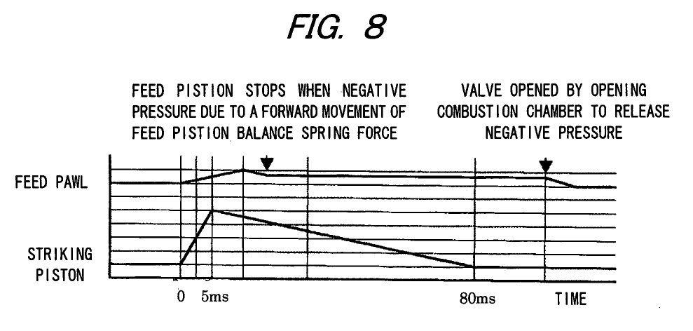

As described above, because the feeding operation of the feed piston 22 is delayed from the returning operation of the striking piston 10, the scraping against the driver 11 can be surely prevented. Thus, the striking operation can be performed by maximizing the use of the pressure of the combustion gas. The shift of the timings between the striking piston 10 and the feed pawl 23 (or the feed piston) is shown in FIG. 8.

Further, the opening valve 32 is provided inside the guide member 30 of the driver 11, i.e., inside the nailer. Thus, even when the nailing operation is carried out in an environment where dust such as wood chips or fine particles of concrete are likely to be attached, the sealing property of the opening valve 32 is ensured. Thus, the operation of the feed piston 22 can be surely delayed.

The delay mechanism of the feeding operation of the feed piston 22 may be configured such that engaging means (not shown) is integrally formed not with the link member 19 but with the contact arm 15 at almost the same position as the bottom portion 19a of the link member 19 so as to be able to engage with the valve stem 35 of the opening valve 32, and that the engaging means engages with the valve stem 35 of the opening valve 32 to push it down when the nailer moves up due to a reaction generated immediately after the nailing where the contact arm 15 moves downward along the nose portion 6 due to its own weight. Thus, the opening valve 32 opens the rear space 40 of the feed piston 22 to the outer air so that the air is suctioned into the feed cylinder 21 via the opening valve 32, whereby the pressure inside the feed cylinder increases. Accordingly, the feed piston 22 moves in the nail feed direction by the force of the spring 27, and the front nail N1 is supplied into the nose portion 6, whereby the next nailing operation is prepared. In this case, the feeding operation of the feed piston 22 is also delayed from the returning operation of the striking piston 10. Thus, the scraping against the driver 11 can be surely prevented.

In the above configuration, while the nailing operation is not performed, the engaging means of the contact arm 15 is separated from the opening valve 32 so that the opening valve 32 is closed.

The delay mechanism of the feeding operation of the feed piston 22 may be configured by an electromagnetic valve which opens the opening valve 32 after or just before the completion of the returning operation of the striking piston 10.

In this case, the opening valve 32 may be set to be opened upon the lapse of a suitable time after igniting the ignition plug.

Further, the delay mechanism of the feeding operation of the feed piston 22 may be configured such that, instead of providing the opening valve, a narrowing hole (not shown) is provide at the check valve 28 at the rear portion of the cylinder 22. According to this configuration, when pressure of the gas tube 26 becomes a negative value after the completion of the driving operation so that the feed piston 22 is operated by the spring 27, outer air is gradually supplied into the rear space 40 of the feed cylinder 21 from the narrow hole by small amount, whereby the operation of the feed piston 22 is braked. Thus, this operation can be delayed with respect to the operation of the striking piston 10.

Although in this embodiment, the contact member is explained as the contact arm which operated separately from the nose portion, the contact member may be configured as a contact nose in which a tip end and the nose portion are integrally formed.

The magazine is not limited to the cylindrical magazine 3 but may be a straight magazine in which fasteners are fed by the feed pawl.

Although the invention has been explained as to the particular embodiment, it would be clear for those skilled in the art that various modifications and changes may be made so long as not departing from the sprit and the range of the invention.

The present application is based on Japanese Patent Application (Japanese Patent Appln. No. 2005-144123) filed on May 17, 2005, the contents of which is incorporated herein by reference.

### INDUSTRIAL APLICABILITY

The feeding operation of the feed piston of the feed piston-cylinder mechanism can be delayed.

1. A gas combustion type striking tool comprising:
a combustion chamber inside which mixed gas obtained by mixing and stirring combustible gas and air is combusted;
a striking piston which is driven by an action of the combustion gas;
a driver which is coupled to a lower surface of the striking piston;
a nose portion which guides the driver to slide and from which a fastener is struck;
a feed pawl which is engagable with coupled fasteners housed inside a magazine;
a feed piston which is coupled to the feed pawl and reciprocates the feed pawl along a direction in which the fattener is fed toward the nose portion;
a check valve which is provided at a rear end portion of a feed cylinder inside which the feed piston is accommodated; and
an opening valve communicating with a rear portion of the feed cylinder,
wherein the feed piston is biased by a spring toward the direction in which the fattener is fed toward the nose portion,
a front portion of the feed cylinder communicates with the combustion chamber, and
the opening valve is opened after or just before a completion of a returning operation of the striking piston.

2. The gas combustion type striking tool according to claim 1, further comprising:
a link member which is coupled to a side wall of the combustion chamber, extends dounwardly from the striking cylinder, and is movable in a vertical direction; and
a contact member which is disposed so as to be engagable with the link member, and is relatively movable along the nose portion in the vertical direction,
wherein the link member is constantly biased downward by a spring, and
the opening valve is opened interlockingly with the link member when the link member moves downward together with the side wall of the combustion chamber after the fastener is struck.

3. The gas combustion type striking tool according to claim 1, further comprising:
a link member which is coupled to a side wall of the combustion chamber, extends dounwardly from the striking cylinder, and is movable in a vertical direction; and
a contact member which is disposed so as to be engagable with the link member, and is relatively movable along the nose portion in the vertical direction,
wherein the link member is constantly biased downward by a spring, and
the opening valve is opened interlockingly with a movement of the contact member.

4 The gas combustion type striking tool according to claim 1, wherein the opening valve includes an electromagnetic valve which is opened after or just before the completion of the returning operation of the striking piston.

5. The gas combustion type striking tool according to claim 1, wherein the opening valve is disposed inside the gas combustion type striking tool.

6. A gas combustion type striking tool comprising:
a combustion chamber inside which mixed gas obtained by mixing and stirring combustible gas and air is combusted;
a striking piston which is driven by an action of the combustion gas;
a driver which is coupled to a lower surface of the striking piston;
a nose portion which guides the driver to slide and from which a fastener is struck;
a feed pawl which is engagable with coupled fasteners housed inside a magazine;
a feed piston which is coupled to the feed pawl and reciprocates the feed pawl along a direction in which the fattener is fed toward the nose portion; and
a check valve having a narrowing hole and is provided at a rear end portion of a feed cylinder inside which the feed piston is accommodated,
wherein the feed piston is biased by a spring toward the direction in which the fattener is fed toward the nose portion, and
a front portion of the feed cylinder communicates with the combustion chamber.
